(19) United States
(12) Patent Application Publication
(10) Pub. No.: US 2010/0042450 A1
(43) Pub. Date: Feb. 18, 2010

(54) SERVICE LEVEL MANAGEMENT IN A SERVICE ENVIRONMENT HAVING MULTIPLE MANAGEMENT PRODUCTS IMPLEMENTING PRODUCT LEVEL POLICIES

(75) Inventors: KEVIN M. BINSWANGER, ATLANTA, GA (US); SAMUEL R. EPSTEIN, BOSTON, MA (US); DAVID L. KAMINSKY, CHAPEL HILL, NC (US); JONATHAN M. WAGNER, ROUND ROCK, TX (US); LIFENG ZHANG, ROCKVILLE, MD (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/192,664

(22) Filed: Aug. 15, 2008

(51) Int. Cl. G06Q 10/00

(52) U.S. Cl. 705/7

(57) ABSTRACT

A change can be identified in service level for a Web service for an entity from a first service level to a second service level. Active policies associated with the first service can be retrieved. The active policies can be policies of a set of different management products of a service environment. For each management product, policies associated with the first service level can be deactivated. Policies associated with the second service level can be retrieved. For each management product, policies associated with the second service level can be activated. In one embodiment, the activation and deactivation of policies can occur automatically using a service level manager that programmatically handles service level specific adjustments across management products.

### BACKGROUND OF THE INVENTION

The present invention relates to the field of Web services, service oriented architectures (SOA), and J2EE Application server environments and, more particularly to service level management in a service environment having multiple management products implementing product level policies.

A service is a component implemented in some combination of hardware and software that performs a function for another component. One common type of service is a Web service. Web services are platform independent, stateful software services having well defined input and output parameters. Web services can be combined together and/or integrated within a larger software application to provide a desired programmatic functionality. Web services often execute “in the cloud” meaning that they are executed by server side components, which are deliverable across a network to client devices and/or different servers. More specifically, Web services execute within a service environment, such as a J2EE application server environment. Often the J2EE application server is implemented as middleware (i.e., WEBSPHERE) that seamlessly interacts as a layer of abstraction between front-end and back-end computing components.

FIG. 1 (Prior Art) shows a diagram where services 140 are provided to computing devices 112-114 from a service environment 120. Service environments, such as environment 120, can include discrete management products 122, 123, 124, which establish, manage, and enforce policies affecting service 140 execution. Management products 122, 123, 124 can minimize coding efforts required for service 140 programming by making commonly needed capabilities available without requiring this functionality to be written within service code itself. For example, a security management product can provide security related functions with can be used by any service 140. A performance monitoring management product can provide monitoring functionality, a load balancing management product can provide workload balancing functionality, etc. Using WEBSPHERE as an example, management products having product specific policies can include TIVOLI WORKLOAD SCHEDULE (TWS) 122, ENTERPRISE WORKLOAD MANAGER (EWLM) 123, IBM TIVOLI MONITORING (ITM) 124, TIVOLI BUSINESS SYSTEMS MANAGER (TBSM), and the like.

Services 140 are often provided to requesting devices 112-114 at different levels of service. For example, the same service 140 can be provided to different devices 112-114 at a gold service level 130, a silver service level 132, and a bronze service level 134. Service level divisions and names are arbitrary and any number of different service level divisions can exist. In one embodiment, different price structures can exist for each service level 130-134. In another embodiment, a relative “importance” of different execution instances can be established and ones that are more important can be assigned a preferred service level relative to those execution instances determined to be of lesser importance. Each service level 130-134 can be associated with different set of execution characteristics. For example, an average response time (ART) of one second can be specified for a service 140 delivered at a “gold” level 130, an ART of two seconds for a “silver” level 132, an ART of four seconds for a “bronze” level 134, etc. Execution characteristics defined for a given service level 130-134 can span across different policy domains, such as domains for security, performance, monitoring, business logic, and the like.

At present, no service level based interactions are conducted between different management products 122-124. That is, one management product (e.g., TWS) 122 with a “gold” service level 130 has no inherent relationship to a “gold” service level 130 in a different management product (e.g., EWLM) 123. Further, management of the policies 128 for different management products 122 is performed in an ad hoc manner. Policies 126 for one managed product 122 are handled separately from policies 128 of another management product 123. Changing a service level 130-134 involves making multiple policy changes 128 in multiple management products 122-124. Further, policy changes have conventionally been manually performed by human administrators (or technicians). Different human administrators can be responsible for making policy changes for different management products 122-124. This type of management of policies 128 is inherently error prone and inefficient.

### BRIEF SUMMARY OF THE INVENTION

The present invention can be implemented in accordance with numerous aspects consistent with the material presented herein. For instance, one aspect of the present invention can include a method, computer program product, and system for managing service level policies across management products in a service environment. In this aspect, a desired change in service level for a service for an entity from a first service level to a second service level can be identified. Active policies associated with the first service can be retrieved. The active policies can be policies of a set of different management products of a service environment. For each management product, policies associated with the first service level can be deactivated. Policies associated with the second service level can be retrieved. For each management product, policies associated with the second service level can be activated.

In another aspect, a service environment configured to provide at least one service can be identified. The service environment can include a set of management products. Each of the management products can include a set of at least one configurable policy specific to that product. A configuration of the configurable policies can affect an execution characteristic of a provided service. A set of different service levels can be established for the at least one service. Each of the different service levels can be associated with a service level specific set of execution characteristics. Each service level can correspond to a set of policies established via a plurality of different management products. Management of service level specifics for the service environment can be centralized using a service level manager external and independent of each of the management products. The service level manager can be communicatively linked to each of the management products and can be configured to determine current policy settings of each of the management products.

### BRIEF DESCRIPTION OF THE SEVERAL VIEWS OF THE DRAWINGS

FIG. 1 (Prior Art) shows a diagram where services are provided to computing devices from a service environment.

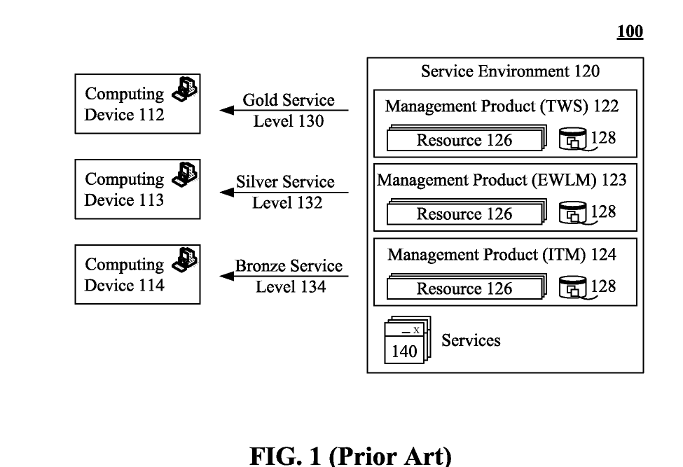

FIG. 2 is a schematic diagram showing a service environment that includes a service level manager in accordance with an embodiment of the inventive arrangements disclosed herein.

### DETAILED DESCRIPTION OF THE INVENTION

The present invention provides a solution for adding a service level manager to a service environment, which handles policy changes related to different service levels across multiple management products. That is, different management products of a service environment can include configurable policies controlling execution characteristics of a services. These characteristics can include, for example, security characteristics, performance characteristics, load balancing characteristics, metric gathering characteristics, and the like. When a service level is to be changed, a change request can be submitted to the service level manager. The manager can then interact with a set of management products to make policy changes in accordance with the new service level specified in the change request. In one embodiment, a database can be maintained that relates policies of a service environment to service levels and optionally to a policy domain. In one embodiment, service level software routines (e.g., shims or plug-ins) can be placed in each management product. The service level manager can interact with these shims, where shims are able to perform intra-management product adjustments based upon service level manager commands.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk—read only memory (CD-ROM), compact disk—read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, for instance, via optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

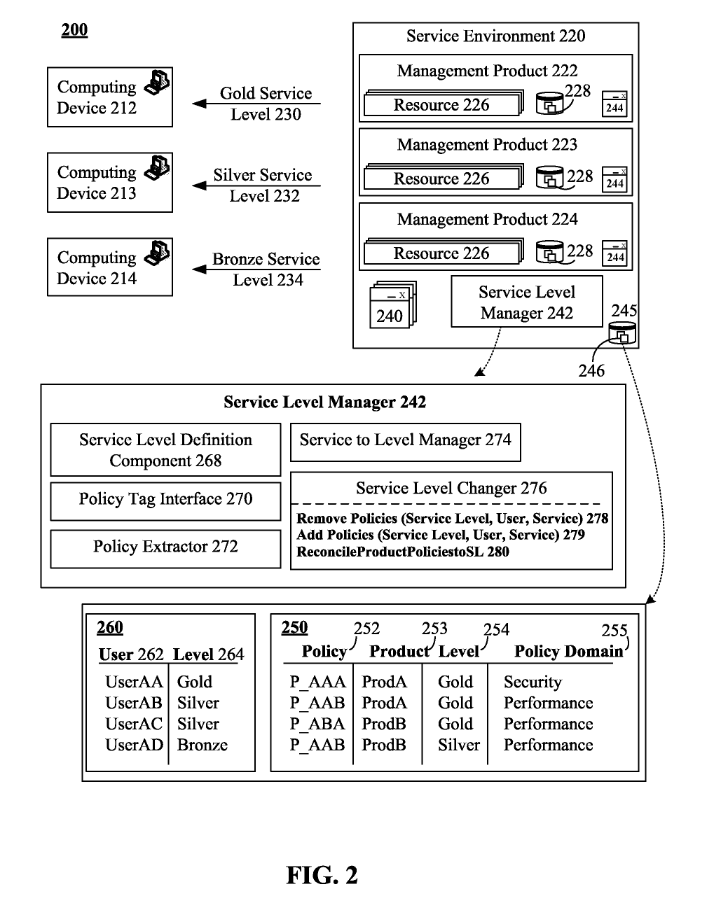

FIG. 2 is a schematic diagram 200 showing a service environment 220 that includes a service level manager 242 in accordance with an embodiment of the inventive arrangements disclosed herein. The service environment 220 can provide services 240 to computing devices 212, 213, 214 at varying service levels, such as a gold 230, silver 232, and bronze 234 level. Each level 230, 232, 234 can be implemented using policies 228 of one or more management products 222, 223, 224. These policies 228 control a manner in which resources 226 of environment 220 are allocated to different service 240 execution instances. Specifics for the different levels of service 230, 232, 324 can be configurable using the service level manager 242. That is, service level manager 242 can be used to as a centralized component for environment 220, which permits an administrator to configure a set of users to utilize a set of services at a defined service level 230, 232, 234. Service level manager 242 can operate across management products 222, 223, 224.

The service level manager 242 can include various components, such as a service level definition component 268, a policy tag interface 270, a policy extractor 272, a service-to-level manager 274, a service level changer 276, and the like. The service level definition component 268 can be used to define execution characteristics for a particular service level. These execution characteristics can apply to a group of services 240 and/or can be applied on a per-service 240 basis. Execution characteristics can include different categories of characteristics, such as security characteristics, performance characteristics, monitoring characteristics, and the like. The different categories can map to policy domains of management products 222, 223, 224. In one embodiment, different characteristic categories can be associated with different service levels. For example, a service 240 can be provided with performance characteristics at a gold level, with security characteristics at a bronze level, and the like.

The policy tag interface 270 can permit a correlation to be established between policies and service levels. In one embodiment, the service level definition component 268 does not necessarily directly map a service level to a policy, but can instead specify “higher level” or more abstract execution characteristics. These characteristics can be mapped to policies 228 by the policy tag interface 270. In another embodiment, the service level definition component 268 can define service levels at a policy level of granularity. In such an embodiment, component 268 and interface 270 can perform effectively the same function; one 268 from a service-level centric perspective, the other from a policy centric perspective.

Assuming an embodiment where policies are directly mapped to service levels, the policy tag interface 270 can directly tag specific policies with a related service level, a policy domain, and the like. For example, table 250 shows a set of records relating different policies 252 to their management products 253, service level 254, and policy domain 255. This type of tagging/database record manipulation can be performed through the policy tag interface 270.

The policy extractor 272 can be a component that queries management products 222, 223, 224 to extract their policies 228 and place them in a centralized data store 245 as records 246 managed directly by manager 242. In one embodiment, software agents 244 can be used during this extraction process. For example, each agent (e.g., shim) can be used to drive command-line APIs to extract policies 228 specific to a management product 222, 223, 224 and to transmit these policies to a centralized repository 245. The policy extractor 272 can iteratively execute to ensure that data store 245 includes current policy data regarding products 222-224.

The service-to-level manager 274 can permit an authorized user to change which service level is associated with an entity, which can be a set of one or more users. For example, manager 274 can permit management of table 260. This table 260 can associate a user identifier 262 with a level of service 264. As shown in table 260, computing device 212 receiving a gold service level 230 can be associated with UserAA. Device 213 receiving a silver service level 213 can be associated with UserAB or UserAC. Device 214 receiving a bronze service level 234 can be associated with UserAD.

The service level changer 276 can include a number of functions that change environment 220 settings in accordance with service level. For example, the service level changer 276 can include a function 278 to remove (e.g., deactivate) all policies established within products 222, 223, 224 matching parameters for a specific service level, user, and service. Service level to policy 228 correlations can be extracted from data store 245. Another function 279 can add (e.g., activate) policies to products 222, 223, 224 given parameters for a service level, user, and service. Other functions can exist in changer 276 module, such as a reconciliation function 280, which attempts to reconcile policy 228 settings of products 222, 223, 224 with values recorded in records 246. Reconciliation actions can provide reports, notification of differences, and/or can automatically change records 246 and/or policies 228 to ensure consistency exists.

To illustrate system 200 in use, assume that policies 228 of management products 222, 223, 224 have been extracted and placed in data store 245, where they are tagged with service level data. Next, an occurrence can cause a UserAA to downgrade from a gold to a silver service level. This occurrence can be triggered by a use of service-to-level manager 274, which changes a record in table 260 so that user 262 is associated with a silver 264 level. Many different product 222, 223, 224 policies 228 can be affected by this change in our example. Once the record change is made for UserAA, a remove policies 278 action can execute. This causes all policies 228 associated with UserAA at the gold level to be removed from management product 222, 223, 224 data stores. Next, an add policy function 279 can execute, which cause policies for the silver level to be added to each management product 222, 223, 224.

As used herein, service environment 220 can represent any computing environment able to provide one or more services 240. The service environment 220 can include a service oriented architecture (SOA) environment, a J2EE environment (e.g., WEBSHERE), and the like.

A management product 222 is a component of environment 220 that provides one or more capabilities affecting an execution of a service 240 within a service environment. Management products 222, 223, 224 can affect security, performance, functionality, monitoring, fault tolerance features, and the like during service 240 execution. Each management product 222 can be a modular product configured to provide runtime governance of services provided via the service environment. For example, in a WEBSPHERE context, management products 222, 223, 224 can include, but are not limited to TIVOLI WORKLOAD SCHEDULE (TWS) 122, ENTERPRISE WORKLOAD MANAGER (EWLM) 123, IBM TIVOLI MONITORING (ITM) 124, TIVOLI BUSINESS SYSTEMS MANAGER (TBSM), and the like.

In one embodiment, the environment 220 can be a SOA environment and the management products 222, 223, 224 can be are configured to monitor, manage, secure, and control end-to-end implementations of SOA-based services and applications for the SOA environment. In another embodiment, the one or more of the management products can conform to an open standard for management products, such as a Web Service Distribution Management (WSDM) standard specified by the J2EE Management specification (JSR) 077.

The service 240 can be a component implemented in some combination of hardware and software that performs a function for another component. Services 240 can respond to messages passed from other components. These messages can conform to a structured format. In some cases, services 240 can expose an application program interface (API), where that API is configured to accept messages. A Web service is one type of service 240.

Each computing device 212-214 can be a device capable of invoking and utilizing services. Computing devices 212-214 can include, but are not limited to, a personal computer, a mobile phone, a Web tablet, a kiosk, a media player, a navigation device, an electronic gaming system, and the like.

Each data store of system 200 (including data store 245 and the data stores for the policies 228) can be implemented as a physical or virtual storage space configured to store digital information. The data stores can be physically implemented within any type of hardware including, but not limited to, a magnetic disk, an optical disk, a semiconductor memory, a digitally encoded plastic memory, a holographic memory, or any other recording medium. Each data store can be a stand-alone storage unit as well as a storage unit formed from a plurality of physical devices. Additionally, information can be stored within data store in a variety of manners. For example, information can be stored within a database structure or can be stored within one or more files of a file storage system, where each file may or may not be indexed for information searching purposes. Further, each data store can utilize one or more encryption mechanisms to protect stored information from unauthorized access.

The various components of system 200 can be communicatively linked to each other via a network. The network can include any hardware/software/and firmware necessary to convey digital content encoded within carrier waves. Content can be contained within analog or digital signals and conveyed through data or voice channels and can be conveyed over a personal area network (PAN) or a wide area network (WAN). The network can include local components and data pathways necessary for communications to be exchanged among computing device components and between integrated device components and peripheral devices. The network can also include network equipment, such as routers, data lines, hubs, and intermediary servers which together form a packet-based network, such as the Internet or an intranet. The network can further include circuit-based communication components and mobile communication components, such as telephony switches, modems, cellular communication towers, and the like. The network can include line based and/or wireless communication pathways.

The diagrams of FIG. 2 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for managing service level policies across management products in a service environment comprising:
identifying a change in service level for a service for an entity from a first service level to a second service level;
retrieving active policies associated with the first service, wherein the active policies are policies of a plurality of different management products of a service environment;
for each management product, deactivating policies associated with the first service level;
retrieving policies associated with the second service level, which at the time of retrieving are not active for the service for the entity; and
for each management product, activating policies associated with the second service level.

2. The method of claim 1, further comprising:
tagging each policy of each management product with a service level, which is used when retrieving policies associated with the first service level and the second service level.

3. The method of claim 2, further comprising:
tagging each policy of each management product with a policy domain, wherein said values for the policy domain comprise domains for at least two of security, performance, monitoring, and business logic.

4. The method of claim 1, further comprising:
extracting active policies implemented within each of the management products;
storing extracted policies in a centralized data store;
for each stored policy adding an attribute and value for a service level for which the policy relates; and
utilizing records and service level values from the centralized data store when retrieving active policies associated with the first service.

5. The method of claim 4, further comprising:
establishing a service level data store of policies that are to be associated with a plurality of different service levels, wherein for each service level a plurality of different policies are associated, wherein these plurality of policies are policies of different management products; and
querying the service level data store for policies associated with the second service level when retrieving policies associated with the second service level.

6. The method of claim 4, further comprising:
deploying a plurality of software agents within different ones of the management products, wherein the software agents are configured to permit a software routine external to the management product to extract active service policies implemented within the management product, wherein the deployed software agents are used when extracting active policies for storage within the centralized data store.

7. The method of claim 1, wherein each of the management products is a modular product configured to provide runtime governance of services provided via the service environment.

8. The method of claim 1, wherein said service associated with the first service level and the second service level is a Web service.

9. The method of claim 7, wherein the service environment is a Service Oriented Architecture (SOA) environment, wherein the management products are configured to monitor, manage, secure, and control end-to-end implementations of SOA-based services and applications for the SOA environment.

10. A computer program product for managing service level policies across management products in a service environment comprising:
a computer usable medium having computer usable program code embodied therewith, the computer usable program code comprising:
computer usable program code configured to identify a change in service level for a service for an entity from a first service level to a second service level;
computer usable program code configured to retrieve active policies associated with the first service, wherein the active policies are policies of a plurality of different management products of a service environment;
computer usable program code configured for each management product, to deactivate policies associated with the first service level;
computer usable program code configured to retrieve policies associated with the second service level, which at the time of retrieving are not active for the service for the entity; and
computer usable program code configured for each management product, to activate policies associated with the second service level.

11. The computer program product of claim 10, further comprising:
computer usable program code configured to tag each policy of each management product with a service level, which is used when retrieving policies associated with the first service level and the second service level.

12. A method for providing services comprising:
identifying a service environment configured to provide at least one service, wherein said service environment comprises a plurality of management products, wherein each of the management products comprises a set of at least one configurable policies specific to that management product, wherein a configuration of the configurable policies affects an execution characteristic of a provided service;
establishing a plurality of different service levels for the at least one service, wherein each of the different service levels are associated with a service level specific set of execution characteristics, wherein each service level corresponds to a plurality of policies established via a plurality of different management products; and
centralizing managing service level specifics for the service environment with a service level manager independent of each of the management products, wherein the service level manager is communicatively linked to each of the management products and is configured to determine current policy settings of each of the management products.

13. The method of claim 12, further comprising:
for each policy implemented within one of the management products, maintaining a service level value associated with that policy.

14. The method of claim 13, further comprising:
identifying management product specific data stores for each of the management products, each configured to maintain policy information for the related management product; and
extracting policy data from the management product specific data stores and placing this extracted policy data within a centralized data store utilized by the service manager, wherein the service level value is associated with each extracted policy maintained within the centralized data store.

15. The method of claim 14, further comprising:
maintaining a software agent within each of the management products, wherein said software agent is used to drive Application Program Interfaces (APIs) used to extract policies of the associated management product.

16. The method of claim 13, further comprising;
associating different ones of the service levels with different entities, each entity comprising a set of at least one user;
receiving a change request to change a service level of one of the entities;
determining using the service level manager all policies across the management products associated with a current service level for the entity;
the service level manager removing the determined policies across the management products associated with the determined policies;
determining using the service level manager new policies across the management products associated with a new service level in accordance with the request to change; and
the service level manager adding the determined new policies across the management products associated with the new policies.

17. The method of claim 12, wherein each of the management products is a modular product configured to provide runtime governance of services provided via the service environment.

18. The method of claim 12, wherein said service provided by the service environment is a Web service.

19. The method of claim 17, wherein the service environment is a Service Oriented Architecture environment, wherein the management products are configured to monitor, manage, secure, and control end-to-end implementations of SOA-based services and applications for the SOA environment.

20. A computer program product for providing services comprising:
a computer usable medium having computer usable program code embodied therewith, the computer usable program code comprising:
computer usable program code configured to identify a service environment configured to provide at least one service, wherein said service environment comprises a plurality of management products, wherein each of the management products comprises a set of at least one configurable policies specific to that management product, wherein a configuration of the configurable policies affects an execution characteristic of a provided service;
computer usable program code configured to identify establish a plurality of different service levels for the at least one service, wherein each of the different service levels are associated with a service level specific set of execution characteristics, wherein each service level corresponds to a plurality of policies established via a plurality of different management products; and
computer usable program code configured to identify centralize managing service level specifics for the service environment with a service level manager independent of each of the management products, wherein the service level manager is communicatively linked to each of the management products and is configured to determine current policy settings of each of the management products.
